(19) United States
(12) Patent Application Publication
(10) Pub. No.: US 2008/0047287 A1
(43) Pub. Date: Feb. 28, 2008

(54) Refrigerator based audio-visual presentation and communication system

(76) Inventor: Jonathan Paul Ruppert, Sacramento, CA (US)

Correspondence Address: PATENT LAW & VENTURE GROUP, 2424 S.E. BRISTOL, SUITE 300, NEWPORT BEACH, CA, 92660, US

(21) Appl. No.: 11/510,181

(22) Filed: Aug. 24, 2006

(51) Int. Cl. A47F 3/04; G09D 3/00; F25B 49/00

(52) U.S. Cl. 62/256; 62/126; 40/107

(57) ABSTRACT

A combination apparatus includes a food storing and preserving machine and an electronic information center. An insulated cabinet provides a door enabling access to a refrigerated interior space within the cabinet. The door incorporates an electronic circuit including a computing unit with a digital data processor, data storage module, and a touch-sense display panel. A plurality of LCD panels are each enabled for displaying photos and other indicia composed from indicia data within the data storage module. A data port is configured for receiving information transmitted by wireless means. A software program in conjunction with the computing unit receives information at the data port and stores the information in the data storage module. Operational options may be displayed on the touch-sense display unit for manually directing the computing unit for displaying the indicia on the LCD panels.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”

Not applicable.

### BACKGROUND OF THE INVENTION

1. Field of the Present Disclosure

This invention relates to methods and devices of displaying and handling pictorial, textual, audio and visual information, and more particularly to an electronic circuit and software program enabled for such display and handling of information.

2. Description of Related Art including information disclosed under 37 CFR 1.97 and 1.98

Kim, et al., U.S. 2004/0035123, discloses a refrigerator having a cooling compartment that provides a memory storing data about a user and data on food items stored in the cooling compartment; a user recognition device recognizing a present user; a controller reading the food item data corresponding to the user data relevant to the present user recognized by the user recognition device; and a display displaying the food item data read by controller. Thus, the refrigerator may be provided, which displays food item information appropriate to a user and reflecting the user's taste, physical constitution and health condition.

Roh, et al., U.S. 2003/0167785, discloses a refrigerator which is capable of being connected to the Internet and performing a variety of multimedia functions, and a method for controlling the same. A multimedia controller which controls the multimedia functions of the refrigerator is driven under the control of a refrigerator controller which controls refrigerating and freezing environments of the refrigerator. Even when an accident, such as a power failure or etc., occurs, the multimedia controller is given time in which it can be normally or closed down or ended. Therefore, a warning window is not displayed on a display unit of the refrigerator upon the driving of the multimedia controller, thus reassuring a user that the refrigerator has not failed.

Lee, U.S. 2003/0110784, discloses an invention that relates to a display apparatus for a refrigerator. In the present invention, the display apparatus is constructed by using a single-sided board 30 with circuit patterns 32 formed on one side thereof. The single-sided board 30 is formed with through-holes 33 through which jumper wires 34 pass so as to connect circuit patterns spaced far apart from one another among the circuit patterns 32. Remaining portions of the jumper wires 34 except the portions thereof connected to the circuit patterns 32 are disposed on a side of the board with no circuit patterns formed thereon. Light-emitting devices 40 are mounted on the single-sided board 30 so that the circuit patterns 32 and leads 42 of the light-emitting devices are electrically connected with one another. The light-emitting devices 40 receive electrical signals through the circuit patterns 32 by means of the electrical connection of the leads 42 with the circuit patterns 32, and selectively emit light so as to display information. According to the present invention, there are advantages in that production costs are decreased, the assembly work is simplified, a defective proportion is reduced, and durability of the display apparatus is improved.

Ferragut, et al., U.S. 2003/0014259, discloses a method and system for a refrigerator that has an integrated presentation mode. The refrigerator includes a cabinet, a refrigerating compartment disposed within the cabinet, a display operatively connected to the cabinet, an intelligent control electrically connected to the display, wherein the intelligent control is adapted to provide a product message related to the refrigerator on the display. The method includes providing a refrigerator adapted for communicating an audio-visual message containing product information about the refrigerator, playing an audio portion of the message, and displaying a visual portion of the message.

Yu, U.S. 2002/0166329, discloses an apparatus and a method for displaying a power-off state of a refrigerator having plural chambers when a user turns off at least one of plural chambers installed to the refrigerator, a power-off state display apparatus of a refrigerator that includes a signal generating unit for generating a power-off signal when a user turns off at least one of plural chambers installed to a refrigerator; and a display unit for displaying a power-off state after receiving the power-off signal.

Roh, et al., U.S. 2001/0054291, discloses a system and method for controlling a refrigerator capable of transmitting and receiving information over an external communication network. A display unit is installed on the front surface of the refrigerator, and a touch panel is connected to the display unit to input a variety of user commands. A schedule management function, a self-diagnosis management function and a component replacement time management function are performed and, if an emergency situation occurs while those functions are performed, a pop-up message is outputted to the screen and information related to the pop-up message is transmitted over the external communication network. Therefore, the user can recognize an emergency situation at an accurate date, manage the refrigerator more efficiently and rapidly and handle information more conveniently. A touch panel and a radio remote controller are selectively used to input a variety of function key signals enabling a user to watch television through the display unit. Therefore, during housekeeping, the user can conveniently watch the television, enter desired key signals or check delivered mails or character messages based on key inputs entered by himself or herself. A camera and microphone are provided to send and receive image and voice mails, thereby removing the inconvenience of key input.

Yun, U.S. 2001/0052741, discloses an invention that aims to construct a display unit installed in a front surface of a door of a refrigerator such that its installation angle can be adjusted. According to the present invention, there is provided an installing structure for the display unit of the refrigerator for tiltably installing the display unit in the front surface of the door of the refrigerator. The installation structure comprises an accommodating portion recessed into the front surface of the door for receiving the display unit; a supporting means for supporting both sides of the display unit so that a vertical tilt of the display unit can be adjusted within the accommodating portion; and a fixing means for securing and supporting the display unit, which has pivoted on the supporting means, at a predetermined tilted position. Thus, according to the present invention, there is an advantage in that an installation can be adjusted so that a user can view clearest scenes on the display unit at the installation angle.

Dwyer, et al. U.S. 2001/0013187, discloses a magnetically mounted display board that has a rear surface providing magnetic support, a display panel which removably holds flat articles for display, and a transparent protectant for viewing and protection of the displayed articles. The display panel and the transparent protectant are bound together with a binding tape. This allows one to display photos, childrens artwork, calendars, post cards and other flat articles on a refrigerator in a creative, organized and protected fashion.

Song, U.S. Pat. No. 6,927,750, discloses an external display device of a refrigerator which includes a microprocessor enabling a serial data transmission/reception between the external display device and a control unit included in the refrigerator. The microprocessor is coupled with a second microprocessor included in the control unit by two voltage supply lines and a minimum number of data transmission lines. Data transmission/reception between the two microprocessor is carried out in an asynchronous serial manner while using an appropriate data format so that each microprocessor recognizes the operation condition of the counter microprocessor. Accordingly, it is possible to simplify the configuration of signal lines required between the external display device and control unit, irrespective of the complexity of functions required. By virtue of the simplified signal line configuration, it is possible not only to reduce costs, but also to reduce the amount of work required in the passing of signal lines through a hinge hole to couple the external display device to the control unit.

Lindler, U.S. Pat. No. 6,535,139, discloses an electronic picture viewing apparatus for displaying electronic images in a picture frame type setting. The electronic picture viewing apparatus includes a housing having a back wall, a top wall, a bottom wall and a pair of side walls. Each of the side walls has a back edge and a front edge wherein the back edges abut the back wall. A display for displaying an electronic image has a backside integrally coupled to the front edges of the housing. A microprocessor for controlling a video signal to the display is positioned in the housing and operationally coupled to the display. A power supply is operationally coupled to the microprocessor. An interface interfaces a plurality of peripherals with the microprocessor. The interface is positioned in one of the side walls of the housing and operationally coupled to the microprocessor. The display displays an electronic image received from the peripherals.

Jacklin, U.S. Pat. No. 6,396,472, discloses an electronic picture frame that receives a removable flash memory card, or related non-volatile digital recording medium, which exist at miniature scale, having stored images, audio and data and includes means for displaying, arraying, fixing, and generally enjoying same in the traditional modes by which photographic images have been known and cherished over time. Economic efficiency dictates the structure and network and system software are likewise compatible, providing apparatus effective for automatic cycling of digital still photographs, and for use in combination with local area networks. However, the electronic frame functions as a free standing unit and may be used without the need or complex or high technology interfacing assistance. A process for displaying digital still photographs stored on known non-volatile digital storage media is likewise taught.

Curry, et al., U.S. Pat. No. 6,542,497, discloses a localized wireless gateway system that provides wireless telephone communication, and for at least interexchange communication, provides voice telephone access to a public packet data network, such as the Internet. The wireless gateway system includes base station transceivers and a packet service gateway coupling the transceivers to the public packet data network. The packet service gateway compresses and decompresses voice frequency communication signals, and it sends and receives the compressed signals in packet form via the network. The packet service gateway also provides for signaling through the network to establish two-way voice communication sessions. In the preferred implementation, the localized wireless gateway system includes at least one radio port control unit coupled to the base station transceivers for controlling calls through the transceivers. The localized wireless gateway system also includes a telephone switch, such as a digital PBX, selectively providing telephone communication channels between the radio port control unit(s) and the packet service gateway. An access manager controls registration and validation of roaming wireless telephones to utilize the wireless gateway system. The access manager also transmits location information for registered wireless telephones to a home location register database via the network. The communications of the access manager to the home location register database permit telephone authentication as well as maintenance of accurate location information in the home location register identifying the current gateway through which a caller can reach the roaming user's wireless telephone.

Hsu, U.S. Pat. No. 6,374,079, discloses an RF communication module for enabling RF data communication in a wireless communication system. The communication module comprises, a transmitter/receive circuitry for transmitting and receiving data, a RF chipset and microcontroller for enabling and controlling various functions of the RF communication module, an antennae circuitry for enabling function of the transmitter/receive circuitry and a data port for enabling serial communication between the RF module and connected components of a host device, characterized in that the RF communication module functions as a slave module or a controlling module dependent on the host device.

Chu, et al., U.S. Pat. No. 6,920,501, discloses a socket migration architecture for migrating a communication socket among host devices that comprise a plurality of migrateable sockets each operating in conjunction with one of a plurality of applications on a plurality of host devices. Each of the applications may utilize a respective migrateable socket to establish peer-to-peer communications with at least one other application. Upon establishment of such communications, the migrateable sockets may form an association link between migrateable sockets operating on different host devices. When a first application and respective first migrateable socket are migrated from a first host device to a second host device, at least one association link established prior to the migration may be used to re-established peer-to-peer communications as part of the migration event.

Wang, et al., U.S. Pat. No. 6,961,763, discloses an architecture for an automation system that includes look-up services, a soft-state store, and a publication/subscription eventing component. The look-up services maintain a database of a number of devices to be controlled and monitored, and a database of a number of device objects corresponding to the devices. The services can be divided into attribute-based and name-based services. The soft-state store manages variables regarding the devices and the device objects, including heartbeats. The eventing component enables subscriptions to events related to changes in the variables. The architecture can include management daemons, such as a monitoring daemon that detects problems with power line devices.

Mahoney, U.S. Pat. No. 6,940,951, discloses a speech enabled automatic name dialer dialing system for connection to a telephone system, that includes a user computer with a computer-based address book program for retrieval of name-telephone number data for creation of speech enabling phoneme sets for auto dialing by speaking a name, and utilizing telephone application programming interface (TAPI), for use with a telephone systems having telephones with private branch exchanges. There is at least one user computer having a microphone and a speaker; a telephone application programming interface provider installed in the user computer; and at least one loaded address book program or equivalent name-telephone number data base contained in the user computer. The software for the user computer, which accesses the data base, creates the phonemes from names of data sets, receives voice inputs, matches the voice input phonemes to the data and signals to a router and PBX to initiate dialing.

Marman, et al., U.S. Pat. No. 6,624,750, discloses a wireless alarm system that employs two-way transceivers in a network of smoke detectors, a base station, and other sensors. A keypad is not needed because the system is reset by pressing a Test/Silence button built into every detector or sensor. A siren is also eliminated because a sounder in every detector sounds an alarm when any sensor is triggered. This is possible because every detector includes a transceiver that can receive alarm messages from any other detector. AC power wiring is also eliminated because the base station and sensors are battery powered. Only a telephone connection is needed if the system is to be monitored. In apartments or dormitory installations, smoke detectors in one apartment relay alarm messages to the next apartment, and onto the next, and so on, to a centralized base station for the entire facility. The centralized base station can be located in an apartment manager's office for immediate notification of an alarm, improper smoke detector operation, low or missing battery indications, and dirty smoke detector indications. The two-way wireless alarm system can save many lives in apartments, where smoke detectors batteries are often depleted or removed.

The related art described above discloses the use of wireless communication devices, and the posting of indicia from a database to a digital display. However, the prior art fails to disclose a combination for replacing the family display normally found on the kitchen refrigerator. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

It has become commonplace to place photos, business cards, letters, children's art, and other artifacts on the surfaces of refrigerators where such items are held in place by small magnets. In fact, the kitchen refrigerator has assumed a second role; that of family bulletin board. However, two major problems exist when the refrigerator is used as a magnetic bulletin board. First, items held in place by magnets often are dislodged and fall off the refrigerator's surface. These items can become damaged or lost. Second, the surface of the average refrigerator is not large enough to hold all of the items that a typical family might want to post there.

The present invention solves this problem by enabling a very large number of items to be stored and posted on the family refrigerator. This posting function may be enlarged to provide a communications role as well.

The present invention is a combination apparatus including a food storing and preserving machine, such as a refrigerator, and an electronic information center. An insulated cabinet provides a door enabling access to a refrigerated interior space within the cabinet. The door incorporates an electronic circuit including a computing unit with a digital data processor, data storage module, and a touch-sense display panel. A plurality of LCD panels are each enabled for displaying photos and other indicia composed from indicia data within the data storage module. A data port is configured for receiving information transmitted by wireless means. A software program in conjunction with the computing unit receives information at the data port and stores the information in the data storage module. Operational options may be displayed on the touch-sense display unit for manually directing the computing unit for displaying the indicia on the LCD panels. In an alternate embodiment, the electronic circuit portion of the present invention may be enclosed in a relatively flat case and mounted to an ordinary refrigerator door or side panel.

A primary objective inherent in the above described apparatus and method of use is to provide advantages not taught by the prior art.

Another objective is to provide a more convenient and safe manner of using a refrigerator as a family bulletin board.

A further objective is to provide such an apparatus having a phone capability useable in conjunction with the storage of data such as phone numbers stored in the apparatus.

A still further objective is to provide such an apparatus that rotates indicia on the family refrigerator automatically or may be used to conduct presentations.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1A is a front elevational view of a refrigerator with an integral display and communications apparatus and system;

FIG. 1B is a front elevational view of a refrigerator with a magnetically mounted version of the display and communications apparatus and system;

FIG. 2 is a block diagram showing the interrelationship between the several aspects of the present invention; and

FIG. 3 is a perspective view of a distal display unit thereof.

### DETAILED DESCRIPTION OF THE INVENTION

The following description is provided to enable any person skilled in the art to make and use the presently described invention and sets forth the best modes contemplated by the inventors of carrying out their invention. Various modifications, however, will remain readily apparent to those skilled in the art, since the generic principles of the present invention have been defined herein specifically to provide an overall method and devices for a refrigerator based information system.

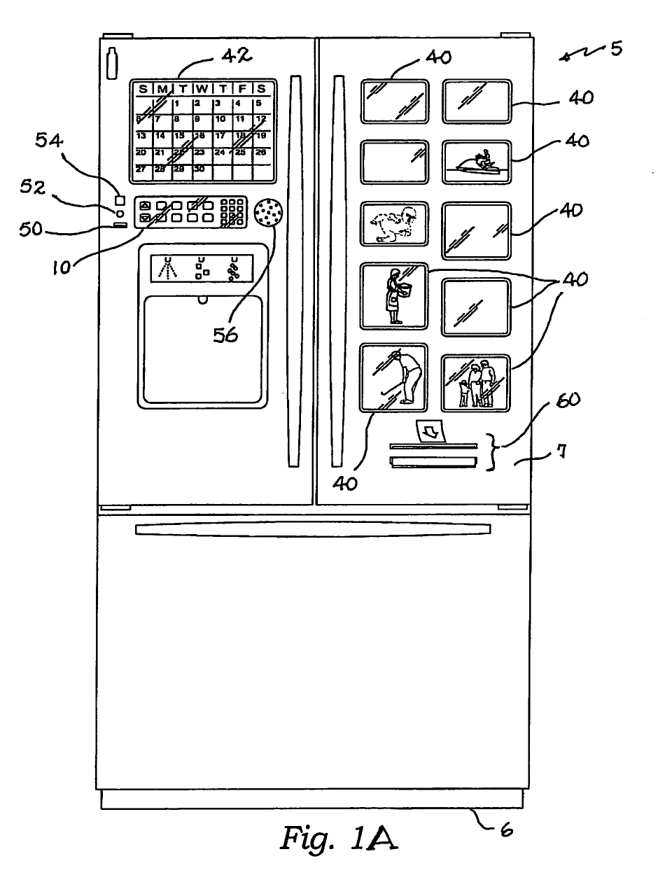

The presently described apparatus may be enabled in two similar embodiments. One, as described below and shown in FIG. 1, is a combination apparatus including a food storing and preserving machine, such as a refrigerator, with a built-in electronic information center, the focus of the present invention. The second, is a separate electronic information center identical to the first embodiment except that it is adapted, by magnetic fixtures, or otherwise, to be more or less permanently fastened to an existing but separate refrigerator. In both cases, the critical elements and the manner in which they operate are the same.

Therefore, now referring to the electronic information center 5, shown in FIGS. 1A, and 1B, several components are operative in achieving the objects described above. The electronic information center 5, as shown in FIG. 1, is encased within a door 7 or other panel of a refrigerator or other like appliance 6, i.e., a freezer appliance, for instance, or it is encased in its own stand-alone enclosure 5′ or enclosures which are adapted to mount, by magnets 5″ or similar means to the door 7 or other panel of the appliance 6 as shown in FIG. 1B. The information center 5 includes a built-in control unit 10 including a digital data processor with operating software program, a data storage module, and a touch-sense screen as a single package. The control unit 10 is mounted so as to be accessible to a person for viewing and selecting choices displayed. It is not meant, herein, to limit the manual control of the present invention to a touch sense panel, as any other well known means for front panel control may be utilized; i.e., buttons, and selection devices such as a computer mouse or roller ball.

The information center 5 also provides a plurality of local LCD display panels 40 which are each enabled, as will be described, for displaying information stored as data within the data storage module of the control unit 10, which is also referred to herein as an electronic circuit. The information center 5 also provides various devices for communication between users and the information center 5, such as a USB port 50 a wireless transceiver 52, a microphone 54 and speaker 56. The operating software program is functional for receiving information through the port 50, transceiver 52 and microphone 54 and storing said information in the data storage module, displaying operational options on the control unit 10, directing operations of the data processor, and displaying information, such as photographs, on each of the display panels 40. The operating software may be enabled for responding to spoken requests by a user with artificial language responses through speaker 56, as are well known in the art so that a “conversation” may be carried on between user and machine as is common with telephone inquires to certain businesses. An example of such a conversation might transpire as follows:
User: “Wake-up”
Machine: “Can I help you”?
User: “Photos”
Machine: “Thirty-five photos stored in memory”
User: “Scan photo”
Machine: “Ready;” “Scanning,” “Please name new photo”
User: “Picnic on June 7^{th}”
Machine: “New photo stored under name picnic on June 7^{th}”
User: “Good-bye”
Machine: “Many thanks and good-bye”

### In this sequence the phrases, “wake-up;” “photos;” “scan photo” and “good-bye” are language elements that the system library has been trained to recognize and take action upon, including verbal responses to the user.

The transceiver 52 is preferably enabled for receiving and sending (transmitting) data by wireless means as for instance by one or more of: IR, WiFi, Bluetooth, RFID and RF transmission technologies or other similar wireless communication methods.

The information handled by the present invention may be: text, pictures, calendars, graphics, symbols, colors and animation as well as any other type of pictorial material that can be presented on the display panels 40. Such LCD panels 40 may alternately be plasma panels or CRT devices or other display units of any kind. For instance, digital photographs may be input via the USB port 50. Photos and other pictorial or textural material may be scanned into a digital form through scanner 70 so as to be stored in the data storage module, and then brought to the display panel 40 for viewing. This simple task takes the place of the mechanical posting of paper-based photographs held on a metal surface such as a refrigerator by magnets, tape or other temporary fasteners. Likewise, a child's art may be scanned into digital form and displayed on one or more of the display panels. Text messages, famous quotes, poems, and text articles may be displayed in this manner also. The presentation of information may be handled in accordance with Ferragut, et al., U.S. 2003/0014259 which is hereby incorporated herein by reference. Lindler, U.S. Pat. No. 6,535,139 teaches the presentation of information on display screens in a manner used in the present apparatus and therefore is herein incorporated into the present disclosure by reference as well.

The software program is enabled for adding to, deleting from, shuffling among, and resizing any of the information that is stored within the present invention. The various display panels 40 may be adjusted as to brightness, contrast, color balance, physical orientation and may be enlarged and cropped and even vignetted as desired using well known software routines that are available to the public. All of these capabilities are well known in editing digital graphics. This capability is particularly useful for posting photographs for family and friends to view wherein the photographs may be digitally altered to optimize their appearance.

Preferably, information in spoken form may be input into the present system using a spoken language recognition software feature, well known in the art, so that information may be adding to, deleting from, shuffling, resized, etc. via voice command. Also, touch-sense selection of options may be used as well or in conjunction with verbal commands.

Preferably, one display panel 42 is functional as a calendar and, through control unit 10 may be set for day, week, month and year views. This panel 42 can be written on to place notes.

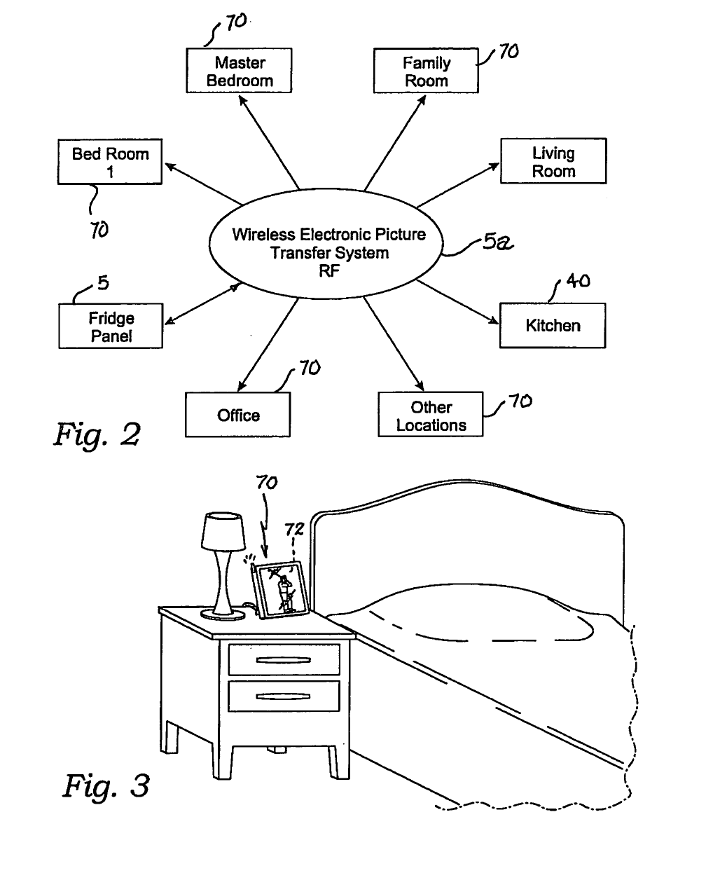

Through the transceiver 52 the system is able to communicate with hand held devices such as cell phones and PDAs and with remote display screen modules 70, as shown in FIG. 3, which are units that may take the form of a wall hung or surface supported picture, and may be battery operated or use house current for operation. Modules 70 are preferably LCD display panels mounted in picture frames for displaying photos or other materials such as with the display modules 40. Through the transceiver 52 of the information center 5 the modules 70, which provide RF receiver and display driver circuitry 72, display information is able to be sent to the modules 70 for display.

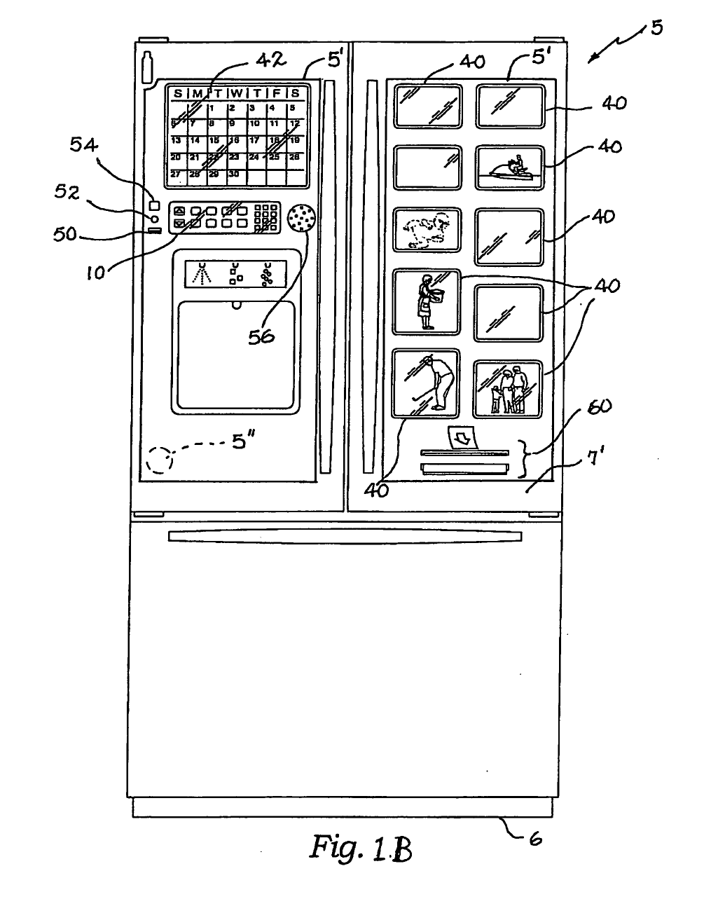

FIG. 2 is a concept block diagram showing that the present invention represented by “Fridge Panel” 5 is able to communicate using a wireless electronic picture transfer system 5a, preferably RF based to send information to a host of remote display modules 70 within a certain limited transmission distance such as 400 feet or less. Such a transfer system 5a includes control unit 10, transceiver 52, receiver and display driver circuitry 72. This wireless system is preferably in communication with one or more public telephone systems including cell phone systems, as is well known in the art and with the Internet via a wireless connection as is taught by Roh, et al., U.S. 2003/0167785 which is hereby incorporated by reference herein. Curry, et al., U.S. Pat. No. 6,542,497 discloses a wireless gateway system that provides telephone communications and is hereby incorporated herein by reference as one manner of achieving the utility of the present apparatus. Mahoney, U.S. Pat. No. 6,940,951, discloses a speech enabled automatic name dialing system for connection to a telephone system, that includes a user computer with a computer-based address book program for retrieval of name-telephone number data. Mahoney is hereby incorporated herein by reference to enable this aspect of the present invention.

Preferably, the software in the present invention further comprises a word recognition parser so that scanned business cards, and other text based items, having telephone numbers thereon are able to be recalled by verbal commands and the telephone numbers automatically dialed using the transceiver 52. To accomplish this, the system includes a phone dialing enablement as part of the software protocol of the system.

The system is enabled for setting time durations and order sequencing as is well known. Therefore, the transmission and display of graphic or other information may be set to change periodically so that, for instance the local display modules 40 and the remote display modules may change views on a scheduled basis. In this way, the indicia displayed may be programmed to rotate in any selected sequence onto the LCD panels. This may be done to provide a video show to those sitting around the counter in a kitchen, or to provide a refreshing constantly changing review of pictures, art and other items from day to day at any or all of the display devices. The information displayed may be: text, pictures, calendars, graphics, symbols, colors and animation.

The intent of the present invention is to present pictorial information at a plurality of display screens both local having wired communication links, and remote through wireless transmission, wherein the type of material displayed and the scheduling of such information is programmable at a base station mounted on or in an appliance. Clearly, the appliance may be replaced by any structural surface such as a wall with the present invention built into the wall or hung, or otherwise attached to the wall.

Clearly, the electronic communication center 5 may be mounted and used as a base unit, and, since it may be attached to a refrigerator or other appliance or a surface of choice, and in a further smaller embodiment, it may be demounted and used as a portable unit movable from room to room to program remote LCD panels by line-of-sight or near line-of-sight communication techniques such as ultrasonic, infra-red, or blue tooth.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A combination apparatus integrally including a food storing and preserving machine and an electronic information center comprising: an insulated cabinet providing at least one door enabling access to a refrigerated interior space within the cabinet, the at least one door incorporating an electronic circuit including:
a) a computing unit including a touch-sense display unit having a digital data processor, and a data storage module;
b) a plurality of local LCD panels, each of the local LCD panels enabled for displaying an indicia composed from data stored within the data storage module;
c) a communication port; and
d) a software program stored within and functional with the computing unit thereby enabling: receiving and sending information at the communication port, storing said information in the data storage module, displaying operational options on the touch-sense display unit, directing operations of the computing unit, and forming the indicia on each of the local LCD panels from the indicia data.

2. The apparatus of claim 1 wherein the indicia data are displayable on the local LCD panels as at least one of: text, pictures, calendars, graphics, symbols, colors and animation.

3. The apparatus of claim 1 wherein the communication port is enabled for receiving and transmitting data by one of: USB, IR, WiFi, Bluetooth, RFID and RF transmission techniques.

4. The apparatus of claim 3 further comprising at least one remote LCD panel having a wireless receiving port, the LCD panel configured thereby for receiving wireless transmissions carrying the indicia data from the communication port, the remote LCD panel enabled for presenting the indicia data on the remote LCD panel as at least one of: text, pictures, calendars, graphics, symbols, colors and animation.

5. The apparatus of claim 1 wherein the software program is enabled for adding to, deleting from, shuffling among, and resizing indicia displayed on the local LCD panels.

6. The apparatus of claim 5 wherein the electronic circuit further comprises a microphone; and the software program further comprises a spoken language recognition feature so that the adding to, deleting from, shuffling among, and resizing of the indicia is carried out by voice command.

7. The apparatus of claim 6 wherein the electronic circuit further comprises a scanner and the software program further comprises a scanned image reading capability functional for storing a scanned image as indicia data in the data storage module.

8. The apparatus of claim 7 wherein the software program further comprises a word recognition parser so that scanned business cards having telephone numbers thereon are able to be recalled by verbal command and the telephone numbers automatically dialed.

9. The apparatus of claim 1 wherein the electronic circuit further comprises a timer and the software program further comprises a program portion enabled for setting a time duration and order of display of the indicia data on the local LCD panels.

10. An electronic information center apparatus for mounting on a refrigeration machine, the apparatus comprising: an electronic information center incorporating an electronic circuit including:
a) a computing unit including a touch-sense display unit, a digital data processor, and a data storage module;
b) a plurality of local LCD panels, each of the local LCD panels enabled for displaying information composed from information stored within the data storage module;
c) a communication port; and
d) a software program stored within and functional with the computing unit thereby enabling: receiving and sending information at the communication port, storing said information in the data storage module, displaying operational options on the touch-sense display unit, directing operations of the computing unit, and forming the indicia on each of the local LCD panels from the indicia data.

11. The apparatus of claim 1 wherein the indicia data are displayable on the local LCD panels as at least one of: text, pictures, calendars, graphics, symbols, colors and animation.

12. The apparatus of claim 1 wherein the communication port is enabled for receiving and transmitting data by one of: USB, IR, WiFi, Bluetooth, RFID and RF transmission techniques.

13. The apparatus of claim 3 further comprising at least one remote LCD panel having a wireless receiving port, the LCD panel configured thereby for receiving wireless transmissions carrying the indicia data from the communication port, the remote LCD panel enabled for presenting the indicia data on the remote LCD panel as at least one of: text, pictures, calendars, graphics, symbols, colors and animation.

14. The apparatus of claim 1 wherein the software program is enabled for adding to, deleting from, shuffling among, and resizing indicia displayed on the local LCD panels.

15. The apparatus of claim 5 wherein the electronic circuit further comprises a microphone; and the software program further comprises a spoken language recognition feature so that the adding to, deleting from, shuffling among, and resizing of the indicia is carried out by voice command.

16. The apparatus of claim 6 wherein the electronic circuit further comprises a scanner and the software program further comprises a scanned image reading capability functional for storing a scanned image as indicia data in the data storage module.

17. The apparatus of claim 7 wherein the software program further comprises a word recognition parser so that scanned business cards having telephone numbers thereon are able to be recalled by verbal command and the telephone numbers automatically dialed.

18. The apparatus of claim 1 wherein the electronic circuit further comprises a timer and the software program further comprises a program portion enabled for setting a time duration and order of display of the indicia data on the local LCD panels.
